(19) United States
(12) Patent Application Publication
(10) Pub. No.: US 2013/0314927 A1
(43) Pub. Date: Nov. 28, 2013

(54) SECONDARY OPTICAL LENS FOR LAMP

(71) Applicants: Kyung Pil Chae, Seoul (KR); Youn Mo Jeong, Seoul (KR)

(72) Inventors: Kyung Pil Chae, Seoul (KR); Youn Mo Jeong, Seoul (KR)

(73) Assignee: LG INNOTEK CO., LTD., Seoul (KR)

(21) Appl. No.: 13/976,795

(22) PCT Filed: Dec. 28, 2011
(86) PCT No.: PCT/KR2011/010193

§ 371 Date: Jun. 27, 2013

(30) Foreign Application Priority Data
Dec. 30, 2010 (KR) 10-2010-0139351

(51) Int. Cl. F21V 5/04

(52) U.S. Cl. CPC F21V 5/046
USPC 362/329; 362/335

(57) ABSTRACT

A secondary optical lens for a lamp is provided, in which the length of one of two axes passing the center of the bottom surface of the lens has minimal value and the projection surface is formed integrally in a three dimensional shape similar to the bottom surface wherein uniform light distribution with at least one curvature point is realized to resolve public nuisance due to stray light and dazzling in diverse indoor and outdoor environments. In addition, the brightness of lighting and energy efficiency may be improved through uniform lighting distribution. Moreover, the bottom surface of the lens and the projection surface can be fabricated with single molding process, so manufacturing process may be simplified and production cost saving is available.

### TECHNICAL FIELD

The present invention relates to a secondary optical lens for a lamp.

### BACKGROUND ART

Generally, a natrium (Na) lamp, a mercury lamp or a metal halide lamp has been used as a city lighting lamp. Such a lamp considerably consumes electric power, and has a short life, and requires a high maintenance cost and contaminates environment. Therefore, it is a surprising event in a field of illumination that a prior lamp device is replaced with a LED (Light Emitting Diode) lamp device.

Meanwhile, an outdoor lamp such as a LED street lamp is configured in such a manner that it collects the light beams by installing a lens to a cover of lighting equipment, however the light field projected by a prior round lens is a round form, and there is a great difference in brilliance between its center part and surrounding. In practical applications there are many different cases; widening the lighting range in one direction, and narrowing the lighting range in the other direction.

As an example, in case of a road illumination, the lighting range has to be broad and much effective toward a parallel direction to a spreading road and further a lighting angle has to be great. However, in general the lighting range has to be small in a vertical direction to a longitudinal direction of the road in order to prevent waste of electricity and avoid public nuisance of the light to the community. It is common that a LED street lamp provided with a prior round lens tends to get sufficient illumination effect by installing a many of lamp devices in a road spreading direction.

### DISCLOSURE OF INVENTION

### Technical Problem

However, though the multiple lighting devices may improve brightness with overlapped right fields of adjacent lighting devices, illumination intensity distribution is uneven and thus average brightness of a road is low level and uneven such that a brightness of a place right below the illumination device is high and those of the other places are low through a illumination phenomenon like a rib shape wherein patterns of bright and dark shape are alternatively appeared on the light field spreading on the road, and thereby causing an illusion while driving a vehicle, which may lead to a car accident and threaten a safe driving of an automobile.

In addition, even if a road on which vehicles are not driven, stray light may cause problems of public nuisance of the light to the community and dazzling in various indoor and outdoor environments.

FIG. 1 is a simulating view of a lighting distribution of a LED outdoor lamp according to a prior art.

As shown in FIG. 1, in the prior LED outdoor lamp the light distribution is shaped as not an exact rectangle but a similar rectangle. This lighting distribution can be easily found on a LED lamp illuminating a crosswalk.

As described in the forgoing, a prior secondary optical lens for a lamp has a lighting distribution in a shape of a rectangle or a square, and practically does not have other shapes of the light distribution.

### Solution to Problem

In order to resolve the drawbacks, the object of the present invention relates to provide a secondary optical lens for a lamp capable of implementing light distribution in specific shape.

As a means to solve said technological problem, a secondary optical lens for a lamp according to an embodiment of the present invention, may comprise: a bottom surface in which a primary axis and a secondary axis passing the center of the lens have different lengths from each other and the side portions thereof that are parallel to the primary axis and corresponded to the secondary axis are indented inwards; and a projection surface having a consecutive curved surface from the bottom surface, from which a light from a light source is projected.

In addition, a secondary optical lens for a lamp according to another embodiment of the present invention, may comprise: a bottom surface in which at least two secondary axes intersecting perpendicularly to a primary axis passing the center of the lens have different lengths from the length of the primary axis and the side portions thereof that are parallel to the primary axis and corresponded to the secondary axis are indented inwards; and a projection surface having a consecutive curved surface from the bottom surface, from which a light from a light source is projected.

The length of the secondary axis may be shorter than that of the primary axis.

A ratio of a length (a) of the primary axis to a length (b) of the secondary axis may be in a range of 0.2<(b/a)<1.0, on the bottom surface.

The secondary optical lens may have a shape of “8” in appearance.

The secondary optical lens may have an appearance of at least 3 ovals or spheres that are connected consecutively.

The secondary optical lens may further comprise a light source installation groove which is formed on the bottom surface and receives the light source at the intersection of the primary axis and the secondary axis.

The light source installation groove may have a symmetrical or asymmetrical configuration.

The projection surface may have at least one curvature point where the inclinations of tangent lines of the projection surface are exchanged.

The curvature point is formed within a range from 0.3 to 0.7 from the center of the clear aperture in case that at the clear aperture viewed from the longitudinal cross section of the secondary optical lens if a half of the clear aperture is normalized by 1.

The secondary optical lens for a lamp may have a minimal thickness at the intersection of the primary axis and the secondary axis.

The secondary optical lens may be fabricated with any of material among polymers including PC (Polycarbonate), PET (Polyethylene terephthalate Resin) and PMMA (Polymethylmethacrylate), and glass.

The secondary optical lens may have more than 90% of permeability and 1.42-1.69 of refractive index (nd).

The secondary optical lens may be arranged in a form of M×N (M, N are identical or different natural number greater than one) array.

The secondary optical lens may be formed either in a symmetrical light distribution configuration including circles, rectangles and squares or in an asymmetrical light distribution configuration including ovals and polygons.

The secondary optical lens may have a reflective layer formed on the bottom surface.

The reflective layer may be formed by using one process among coating process, printing process and deposition process.

The reflective layer may perform a mirror type Specular reflection or white paint type Lambertian reflection, or both types of reflection.

### Advantageous Effects of Invention

According to the present invention, the secondary optical lens for a lamp is configured in such a manner that the length of one of two axes passing the center of the bottom surface of the lens has a minimal value and the projection surface is formed integrally in a three dimensional shape similar to the bottom surface to have at least curvature point, and thereby forming an uniform light distribution to resolve public nuisance dazzling due to stray light in diverse indoor and outdoor environments.

In addition, the brightness of lighting and energy efficiency may be improved through the uniform lighting distribution.

Moreover, the bottom surface of the lens and the projection surface can be fabricated by using single molding process to simplify manufacturing process and save cost.

### BRIEF DESCRIPTION OF DRAWINGS

The above and other aspects, features and advantages of certain exemplary embodiments of the present invention will be more apparent from the following description taken in conjunction with the accompanying drawings, in which:

FIG. 1 is a simulating view of a lighting distribution of a LED outdoor lamp according to a prior art;

FIG. 2 is a cross-sectional view showing a light distribution of the secondary optical lens for a lamp according to a preferred embodiment of the present invention;

FIG. 3 is a perspective view showing the bottom surface of the secondary optical lens for a lamp in FIG. 2;

FIG. 4 is a perspective view showing a longitudinal cross-section of the secondary optical lens for a lamp in FIG. 2;

FIG. 5 is a perspective view of the secondary optical lens for a lamp in FIG. 2;

FIGS. 6 and 7 are views for describing a clear aperture of the secondary optical lens for a lamp according to a preferred embodiment of the present invention;

FIG. 8 is a perspective view showing the bottom surface of the secondary optical lens for a lamp according to another embodiment of the present invention;

FIG. 9 is a simulation view showing a light distribution (rectangular shape) of the secondary optical lens for a lamp according to another embodiment of the present invention;

FIG. 10 is a simulation view showing a light distribution (oval shape) of the secondary optical lens for a lamp according to another embodiment of the present invention;

FIG. 11 is a view showing an asymmetric shape in which a LED module installation groove is inserted to the secondary optical lens for a lamp according to the present invention;

FIG. 12 is a view showing a symmetric shape in which a LED module installation groove is inserted to the secondary optical lens for a lamp according to the present invention; and

FIG. 13 is a view showing an exemplary array of the secondary optical lens for a lamp according to the present invention.

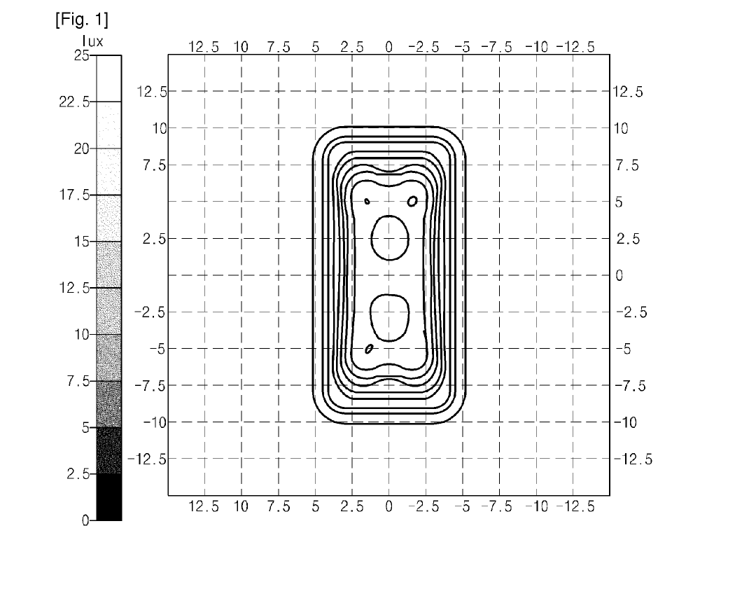

### MODE FOR THE INVENTION

Embodiments of the present invention will be described below in detail with reference to the accompanying views so that those having ordinary skill in the art may easily practice the present invention. However, the present invention may be implemented in various and different forms and not limited to the embodiments described here. In addition, in order to clearly describe the present invention, parts that are not related with the description are omitted, and the same reference numerals will be used to refer to the same elements throughout the specification.

### INDUSTRIAL APPLICABILITY

### A First Embodiment of the Secondary Optical Lens for a Lamp

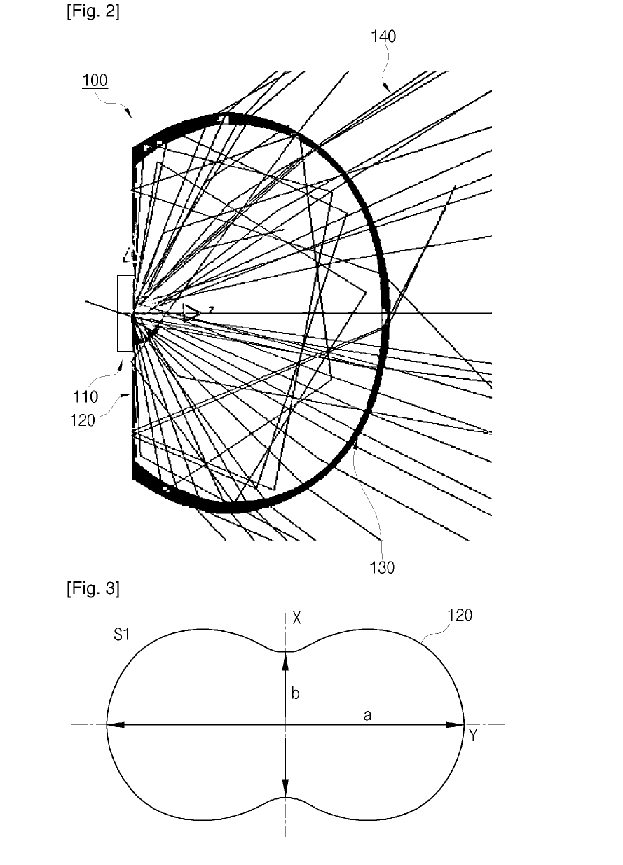

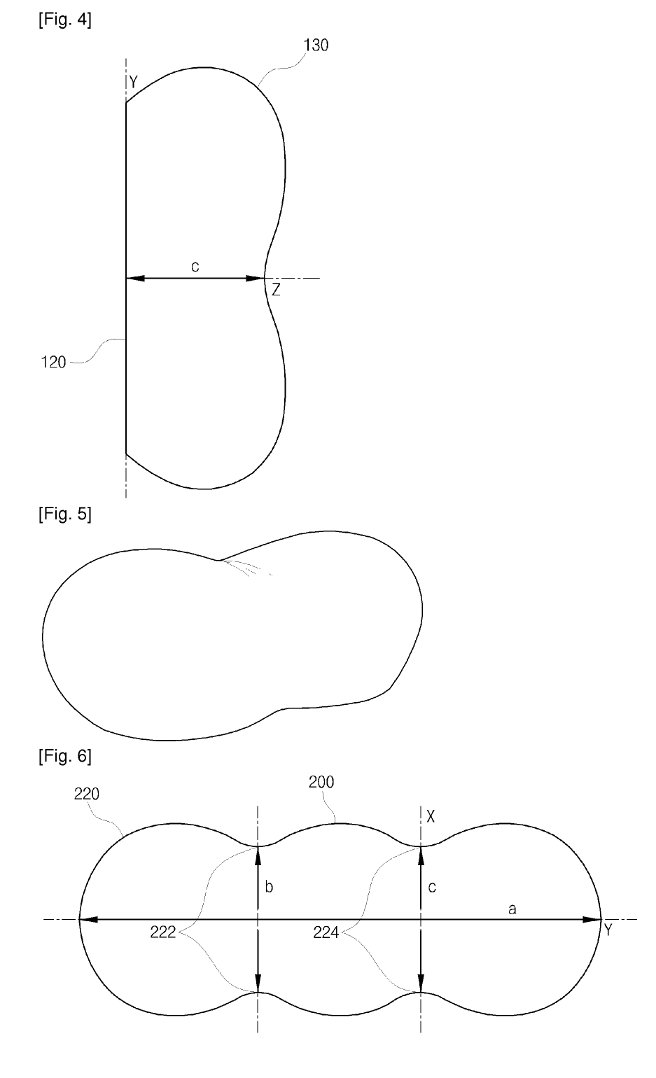

FIGS. 2 to 5 are views showing a configuration of the secondary optical lens for a lamp according to an embodiment of the present invention wherein FIG. 2 is a cross-sectional view showing a light distribution of the secondary optical lens for a lamp according to a preferred embodiment of the present invention, FIG. 3 is a perspective view showing the bottom surface of the secondary optical lens for a lamp in FIG. 2, FIG. 4 is a perspective view showing a longitudinal cross-section of the secondary optical lens for a lamp in FIG. 2, and FIG. 5 is a perspective view of the secondary optical lens for a lamp in FIG. 2.

The secondary optical lens for a lamp 100 according to a first embodiment of the present invention has a shape like a peanut entirely as shown in FIGS. 2 to 5. In more detailed, the secondary optical lens for a lamp 100 of the present invention includes a bottom surface 120, a projection surface 130 from which the light from a LED arranged to the bottom surface 120 is projected outwards, and a LED package 110 arranged to the bottom surface 120.

As illustrated in FIG. 3, the secondary optical lens for a lamp 200 has a shape like a peanut. That is, a transverse axis (x) and a longitudinal axis (y) passing a center of the bottom surface 120 have different lengths from each other, and roughly central portions of transverse sides of the bottom surface 120 are indented inwards. Namely, the bottom surface 120 has inwardly dented portions at the central portions of transverse sides. In other words, the portions 122 corresponding to the transverse axis of the sides that are parallel to longitudinal axis are indented inwards.

As a result, a length among longitudinal center portions 122, that is, a transverse length passing a center of the bottom surface 120 is shorter than the transverse lengths of other portions. Thus, the length of the axis (x) passing the center of the bottom surface 120 in transverse direction has a minimum value necessarily. In other words, the length (a) of y axis passing the center of the bottom surface in the longitudinal direction is longer than the length (b) of the x axis. Additionally, the bottom surface 120 has an axial symmetry since the bottom surface 120 has a symmetrical shape based on two axes (x, y) passing the center of the bottom surface 120. As a result, the appearance of the bottom surface 120 is “8” shaped. Here, a ratio of the length of longitudinal axis (a) to the length of transverse axis (b) may preferably be a range of 0.2<(b/a)<1.0 among two axes (x, y) of the bottom surface 120.

In addition, on the bottom surface 120 a LED groove (not shown) to install a LED is formed at an intersection of the two axes (x, y), that is, at the center of the bottom surface. At this time, the LED installation groove may be formed not only in symmetrical configuration such as a round shape but also in asymmetric configuration such as a oval shape or a polygon.

Further, as shown in FIGS. 4 to 5, a projection surface 130 from which a light from the LED installed to the bottom surface 120 is projected outwards has a three dimensional shape and has a continuous curved surface from an edge of the bottom surface 120, that is, a border.

That is, since a two dimensional optical lens has a three dimensional shape like a peanut, and thus the projection surface 130 is also extended from an edge of the bottom surface 120 to form a three dimensional shape of a peanut, and has one or more curved surfaces. In addition, a roughly central portion 132 of the projection surface 130 is indented inwards into the projection surface 130. As a result, the secondary optical lens may have a minimal thickness (c) at a roughly central portion of the projection surface 130 and as shown in FIG. 4, a longitudinal section of the projection surface 130 has a shape similar to the bottom surface 120.

The projection surface 130 has at least one curvature point between 30% and 70% based on a clear aperture. Here, the clear aperture means the diameter of the porting through which a light ray passes on an optical surface.

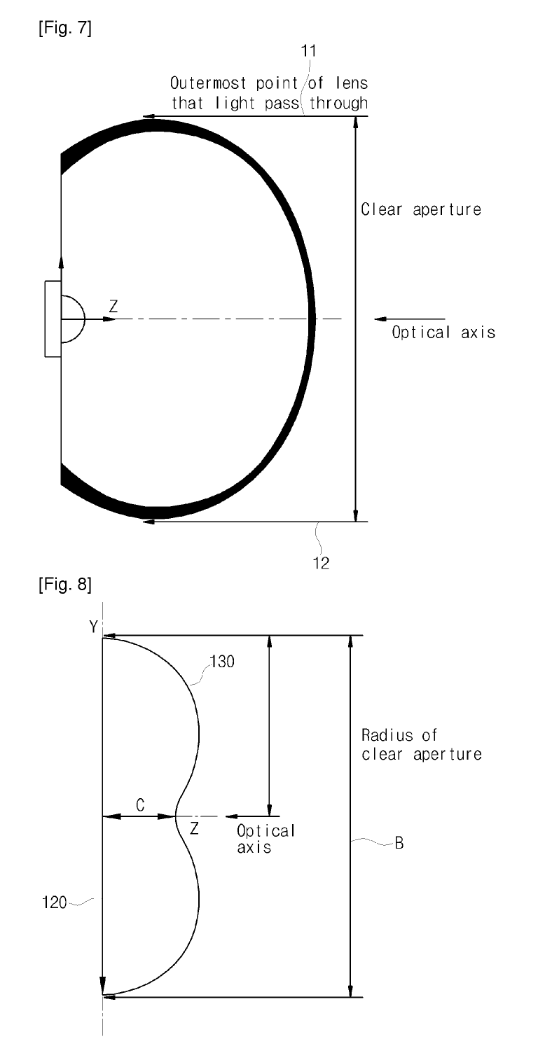

FIGS. 6 to 7 are views to describe the clear aperture of the secondary optical lens for a lamp according to an embodiment of the present invention.

Referring to FIGS. 6 to 7, the clear aperture means a distance between outermost points of the optical surface through which a light passes in the secondary optical lens for a lamp 200. FIG. 6 shows the clear aperture viewed at the transverse section of the secondary optical lens for a lamp 200, whereas FIG. 7 shows the clear aperture viewed at the longitudinal section of the secondary optical lens for a lamp 200.

The curvature point refers to the curved surface within a range of about 0.3 to 0.7 wherein in the clear aperture viewed from a cross section of the secondary optical lens if a half of the clear aperture is normalized by 1, that is, the light axis (z) is set to 0 and the distance from the light axis to one of two outermost points is set to 1, that is, a point 30 where the inclinations of tangent lines of the projection surface are exchanged. The secondary optical lens for a lamp 100 is made of optically transparent material and may have more than 90% of permeability and 1.42-1.69 of refractive index (nd). For instance, the secondary optical lens for a lamp 100 may be fabricated with any of material among polymers including PC (Polycarbonate), PET (Polyethylene terephthalate Resin) and PMMA (Polymethylmethacrylate) and glass.

### A Second Embodiment of the Secondary Optical Lens for a Lamp

The secondary optical lens for a lamp according to a preferred second embodiment of the present invention is same as the secondary optical lens 100 according to the first embodiment of the present invention except for the fact of having a reflective layer on the bottom face. More specifically, the secondary optical lens for a lamp according to the second embodiment of the present invention may improve optical efficiency by forming a reflective layer (not shown) on the bottom surface of the lens and reflecting the light irradiated from a LED to the projection surface.

Here, the reflective layer may perform minor type Specular reflection or white paint type Lambertian reflection, or both types of reflection, and may be formed through coating process, printing process or deposition process.

### A Third Embodiment of the Secondary Optical Lens for a Lamp

FIG. 8 is a perspective view showing the bottom surface of the secondary optical lens for a lamp according to another preferred embodiment of the present invention.

The secondary optical lens for a lamp according to a third embodiment of the present invention 200 includes the bottom surface 220, the projection surface (not shown) from which a light from a LED is projected outwards and a LED package (not shown) which is installed on the bottom surface. The secondary optical lens for a lamp according to a third embodiment of the present invention 200 has a three dimensional peanut shape with 3 consecutive knobs. In other words, the secondary optical lens for a lamp according to a third embodiment of the present invention may have a shape of 3 ovals or spheres that are connected consecutively. The present invention is not limited to this, and it is obvious to a skilled person that the secondary optical lens for a lamp may have four or more knobs, circles or ovals.

In more detailed, the portion 222 about one thirds and the portion 224 about two thirds of longitudinal sides of the bottom surface 220 are indented inwards into the bottom surface 220. That is, longitudinal sides of the bottom surface 220 have 2 portions that are indented inwards at the center of the bottom surface, respectively. In other words, the portions 222, 224 corresponding to 2 transverse axes of the sides that are parallel to longitudinal axis are indented inwards.

As a result, transverse lengths b, c between indented portions 222, 224 of longitudinal sides are shorter than transverse lengths between not indented portions. Here, the transverse lengths b, c between indented portions 222, 224 of longitudinal sides may have roughly identical values, and it is assumed that the transverse lengths b, c are identical hereinafter.

Accordingly, at least one of axes (x) passing across the transverse lengths between indented portions 222, 224 of longitudinal sides and passing the center of the bottom surface 220, which are perpendicular to longitudinal axis (y), may be the shortest(curtailed) transverse axis (x).

That is, the length (a) of y axis passing the center of the bottom surface in the longitudinal is longer than the length (b) of the transverse axis (x). In the present embodiment, the bottom surface 120 has an axial symmetry since the bottom surface has a symmetrical shape based on two axes (x, y) passing the center of the bottom surface 220.

Here, a ratio of the length of longitudinal axis (a) to the length of transverse axis (b) may preferably be a range of 0.2<(b/a)<1.0 among two axes (x, y) of the bottom surface 220.

In addition, on the bottom surface 220 LED grooves (not shown) to install a LED are formed at the intersections of the two transverse axis (x) and one longitudinal axis (y). At this time, the LED installation grooves may be formed not only in symmetrical configuration such as a round shape but also in asymmetric configuration such as a oval shape or a polygon.

Further, even not shown in the drawings, a projection surface from which a light from the LED installed to the bottom surface 220 is projected outwards has a three dimensional shape and has a continuous curved surface from an edge of the bottom surface 220, that is, a border, since the secondary optical lens for a lamp 200 according to a third embodiment of the present invention has a three dimensional peanut shape having three consecutive knobs.

The secondary optical lens for a lamp 200 is made of optically transparent material and may have more than 90% of permeability and 1.42-1.69 of refractive index (nd). For instance, the secondary optical lens for a lamp 200 may be fabricated with any of material among polymers including PC (Polycarbonate), PET (Polyethylene terephthalate Resin) and PMMA (Polymethylmethacrylate) and glass

### Another Embodiment of the Secondary Optical Lens for a Lamp

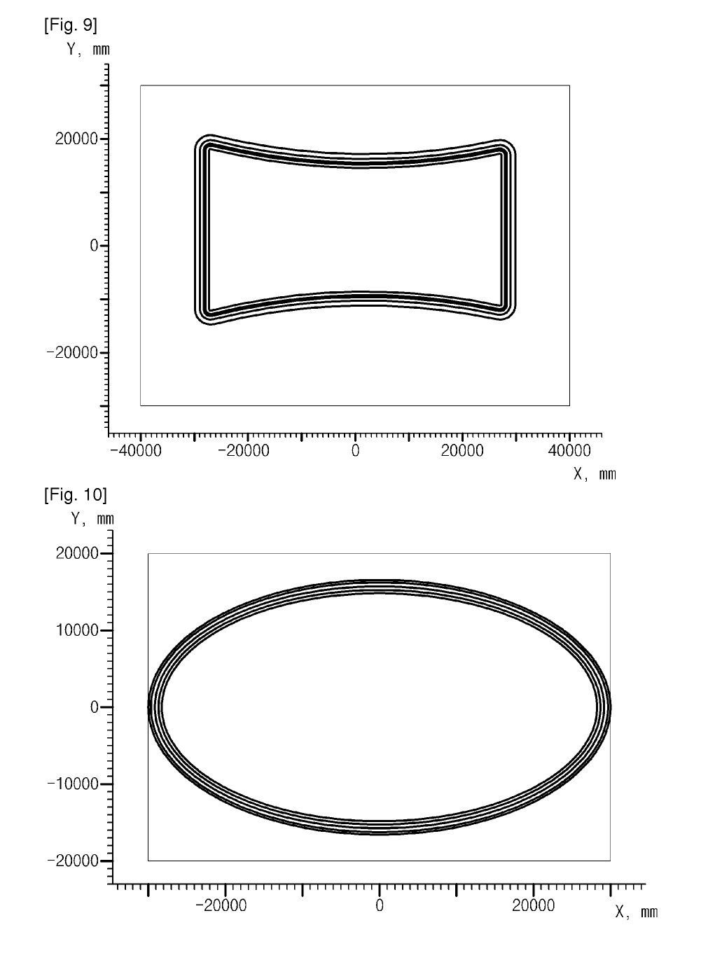

FIG. 9 is a simulation view showing a light distribution (rectangular shape) of the secondary optical lens for a lamp according to another preferred embodiment of the present invention, and FIG. 10 is another simulation view showing a light distribution (oval shape) of the secondary optical lens for a lamp according to another preferred embodiment of the present invention.

The secondary optical lens for a lamp by the present invention may be configured so as to have a light distribution with a shape of a rectangle or an oval as shown in the simulation views of FIGS. 9 to 10. The light distribution may be diversified by varying a ratio of the length (a) of a longitudinal axis (a) passing a center of the bottom surface 120 of the secondary optical lens to the length (b) of a transverse axis. In addition, a light distribution may be diversified by varying the position of a curvature point where the inclinations of the tangent lines of the projection surface are exchanged.

### Another Embodiment of the Secondary Optical Lens for a Lamp

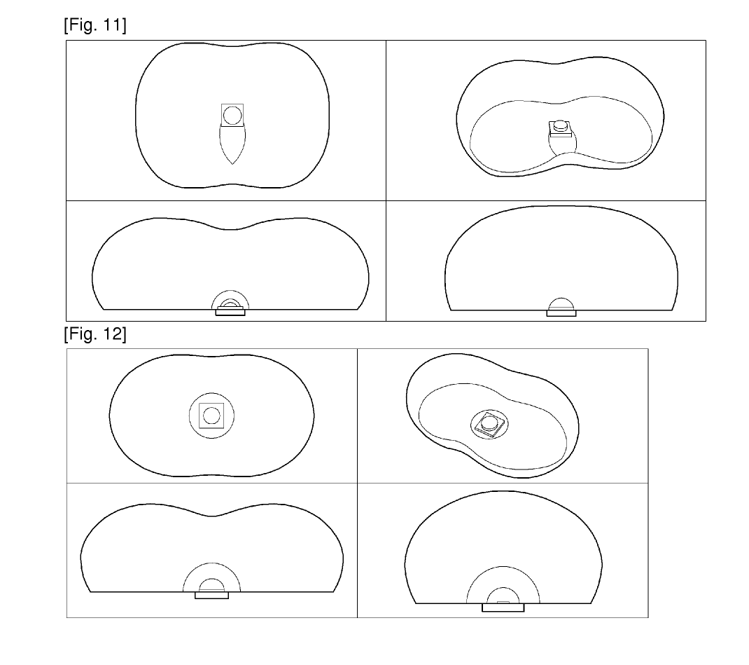

FIG. 11 is a view showing an asymmetric shape in which a LED module installation groove is inserted to the secondary optical lens for a lamp according to the present invention, and FIG. 12 is a view showing a symmetric shape in which a LED module installation groove is inserted to the secondary optical lens for a lamp according to the present invention.

As shown in FIGS. 11 to 12, the secondary optical lens for a lamp according to the present invention may be configured by forming a LED module installation groove integrally within the lens. The LED module installation groove formed within the lens may have an asymmetrical shape as FIG. 11 or a symmetrical shape as FIG. 12.

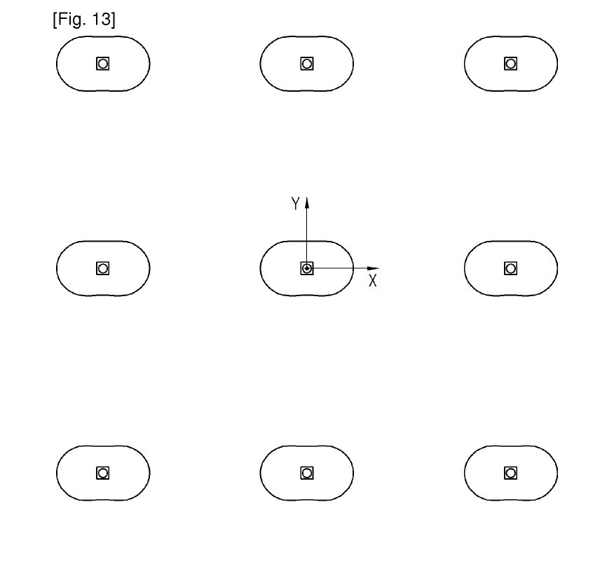

FIG. 13 is a view showing an example of array of the secondary optical lens for a lamp according to the present invention. In FIG. 13, the secondary optical lens has a form of 3×3 matrix, however, the lens may be configured in other shapes. That is, the secondary optical lens according to the present invention may have an array configuration of M×N matrix wherein M and N are natural numbers that may be identical or different from each other.

The secondary optical lens for a lamp according to the present invention is configured in such a manner that the length of one of two axes passing the center of the bottom surface of the lens has a minimal value and the projection surface is formed integrally in a three dimensional shape similar to the bottom surface to have at least one curvature point and thereby forming an uniform light distribution to achieve the object of the present invention.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1-18. (canceled)

19. A secondary optical lens for a lamp, comprising:
a bottom surface in which a primary axis and a secondary axis passing the center of the lens have different lengths from each other and the side portions thereof that are parallel to the primary axis and corresponded to the secondary axis are indented inwards; and
a projection surface having a consecutive curved surface from the bottom surface, from which a light from a light source is projected.

20. The secondary optical lens for a lamp of claim 19, wherein the length of the secondary axis is shorter than that of the primary axis.

21. The secondary optical lens for a lamp of claim 19, wherein a ratio of a length (a) of the primary axis to a length (b) of the secondary axis is in a range of 0.2<(b/a)<1.0, on the bottom surface.

22. The secondary optical lens for a lamp of claim 19, wherein the secondary optical lens has a shape of “8” in appearance.

23. The secondary optical lens for a lamp of claim 19, further comprises a light source installation groove which is formed on the bottom surface and receives the light source at the intersection of the primary axis and the secondary axis.

24. The secondary optical lens for a lamp of claim 23, wherein the light source installation groove has a symmetrical or asymmetrical configuration.

25. The secondary optical lens for a lamp of claim 19, wherein the projection surface has at least one curvature point where the inclinations of tangent lines of the projection surface are exchanged.

26. The secondary optical lens for a lamp of claim 25, wherein the curvature point is formed within a range from 0.3 to 0.7 from the center of the clear aperture in case that at the clear aperture viewed from the longitudinal cross section of the secondary optical lens if a half of the clear aperture is normalized by 1.

27. The secondary optical lens for a lamp of claim 19, wherein the secondary optical lens for a lamp has a minimal thickness at the intersection of the primary axis and the secondary axis.

28. The secondary optical lens for a lamp of claim 19, wherein the secondary optical lens is fabricated with any of material among polymers including PC (Polycarbonate), PET (Polyethylene terephthalate Resin) and PMMA (Polymethylmethacrylate), and glass.

29. The secondary optical lens for a lamp of claim 19, wherein the secondary optical lens has more than 90% of permeability and 1.42-1.69 of refractive index (nd).

30. The secondary optical lens for a lamp of claim 19, wherein the secondary optical lens is arranged in a form of M×N (M, N are identical or different natural number greater than one) array.

31. The secondary optical lens for a lamp of claim 19, wherein the secondary optical lens is formed either in a symmetrical light distribution configuration including circles, rectangles and squares or in an asymmetrical light distribution configuration including ovals and polygons.

32. The secondary optical lens for a lamp of claim 19, wherein the secondary optical lens has a reflective layer formed on the bottom surface.

33. The secondary optical lens for a lamp of claim 32, wherein the reflective layer is formed by using one process among coating process, printing process and deposition process.

34. The secondary optical lens for a lamp of claim 32, wherein the reflective layer performs a mirror type Specular reflection or white paint type Lambertian reflection, or both types of reflection.

35. A secondary optical lens for a lamp, comprising:
a bottom surface in which at least two secondary axes intersecting perpendicularly to a primary axis passing the center of the lens have different lengths from the length of the primary axis and the side portions thereof that are parallel to the primary axis and corresponded to at least one of the secondary axes are indented inwards; and
a projection surface having a consecutive curved surface from the bottom surface, from which a light from a light source is projected.

36. The secondary optical lens for a lamp of claim 35, wherein the length of the secondary axis is shorter than that of the primary axis.

37. The secondary optical lens for a lamp of claim 35, wherein a ratio of a length (a) of the primary axis to a length (b) of the secondary axis is in a range of 0.2<(b/a)<1.0, on the bottom surface.

38. The secondary optical lens for a lamp of claim 35, wherein the secondary optical lens has an appearance of at least 3 ovals or spheres that are connected consecutively.

39. The secondary optical lens for a lamp of claim 35, further comprises a light source installation groove which is formed on the bottom surface and receives the light source at the intersection of the primary axis and the secondary axis.

40. The secondary optical lens for a lamp of claim 39, wherein the light source installation groove has a symmetrical or asymmetrical configuration.

41. The secondary optical lens for a lamp of claim 35, wherein the projection surface has at least one curvature point where the inclinations of tangent lines of the projection surface are exchanged.

42. The secondary optical lens for a lamp of claim 41, wherein the curvature point is formed within a range from 0.3 to 0.7 from the center of the clear aperture in case that at the clear aperture viewed from the longitudinal cross section of the secondary optical lens if a half of the clear aperture is normalized by 1.

43. The secondary optical lens for a lamp of claim 35, wherein the secondary optical lens for a lamp has a minimal thickness at the intersection of the primary axis and the secondary axis.

44. The secondary optical lens for a lamp of claim 35, wherein the secondary optical lens is fabricated with any of material among polymers including PC (Polycarbonate), PET (Polyethylene terephthalate Resin) and PMMA (Polymethylmethacrylate), and glass.

45. The secondary optical lens for a lamp of claim 35, wherein the secondary optical lens has more than 90% of permeability and 1.42-1.69 of refractive index (nd).

46. The secondary optical lens for a lamp of claim 35, wherein the secondary optical lens is arranged in a form of M×N (M, N are identical or different natural number greater than one) array.

47. The secondary optical lens for a lamp of claim 35, wherein the secondary optical lens is formed either in a symmetrical light distribution configuration including circles, rectangles and squares or in an asymmetrical light distribution configuration including ovals and polygons.

48. The secondary optical lens for a lamp of claim 35, wherein the secondary optical lens has a reflective layer formed on the bottom surface.

49. The secondary optical lens for a lamp of claim 48, wherein the reflective layer is formed by using one process among coating process, printing process and deposition process.

50. The secondary optical lens for a lamp of claim 48, wherein the reflective layer performs a mirror type Specular reflection or white paint type Lambertian reflection, or both types of reflection.
